(19) United States
(12) Patent Application Publication
(10) Pub. No.: US 2024/0160457 A1
(43) Pub. Date: May 16, 2024

(54) Multi-User Collaboration Systems, and Methods of Providing Thereof

(71) Applicant: CoLab Software Inc., St. John's (CA)

(72) Inventors: Adam Michael KEATING, St. John's (CA); Jeremy William Andrews, St. John's (CA); Peter Jeffrey GOSSE, Conception Bay South (CA); Levin Stanley MEJIA-KING, Paradise (CA); Robert Raymond Graham PERCY, Conception Bay South (CA)

(21) Appl. No.: 18/508,601

(22) Filed: Nov. 14, 2023

Related U.S. Application Data
(60) Provisional application No. 63/425,433, filed on Nov. 15, 2022.
(60) Provisional application No. 63/438,339, filed on Jan. 11, 2023.

(51) Int. Cl. G06F 9/451; G06F 3/0484

(52) U.S. Cl. CPC G06F 9/452; G06F 3/0484

(57) ABSTRACT

A multi-user collaboration system, and a method of providing the same are disclosed. The method involves creating a workspace to which a plurality of digital materials can be shared by one or more internal users; receiving, from an internal user of the one or more internal users, an external collaboration request to collaborate with an external user type; in response to receiving the external collaboration request: creating a sub-workspace in association with the workspace for the external user type; and assigning a sub-workspace user group to the sub-workspace; and displaying a set of feedback on the one or more digital materials to a user. The sub-workspace is accessible by an external user associated with the external user type to provide a sub-workspace feedback in respect of one or more digital materials of the plurality of digital materials shared to the sub-workspace.

### CROSS-REFERENCE TO RELATED PATENT APPLICATIONS

This application claims the benefit of U.S. Provisional Application No. 63/425,433, filed on Nov. 15, 2022 and U.S. Provisional Application No. 63/438,339, filed on Jan. 11, 2023. The complete disclosure of each of U.S. Provisional Application No. 63/425,433, and U.S. Provisional Application No. 63/438,339 is incorporated herein by reference.

### FIELD

The described embodiments relate to multi-user collaboration systems and methods of providing the multi-user collaboration systems. In particular, the multi-user collaboration systems involve one or more external users.

### BACKGROUND

Online collaborations between different entities are becoming a common method of facilitating completion of projects, such as but not limited to execution of design projects. In addition to increasing the flexibility in which individuals can collaborate and the geographical locations where the entities are located, online collaboration systems can improve the collaboration process, such as but not limited to the effectiveness of how design projects can be executed.

The extent of a collaboration between the different entities may vary in complexity and timeframe. Whatever the type of collaborations these are, it can be difficult to manage these collaborations when multiple individuals are involved at either the engaging entity (or internal entity) and the external entity. Also, there can be instances when the different entities should have varied access to the input received from the individuals. Further, even with a document management system, collaborations between internal and external entities require proper security and access management, and this can be difficult to manage when external parties, and/or multiple external parties are involved.

### SUMMARY

The various embodiments described herein generally relate to methods for providing a multi-user collaboration system involving one or more external users, and multi-user collaboration systems.

In accordance with an example embodiment, there is provided a method of providing a multi-user collaboration system involving one or more external users. The method includes creating a workspace to which a plurality of digital materials can be shared by one or more internal users; receiving, from an internal user of the one or more internal users, an external collaboration request to collaborate with an external user type; in response to receiving the external collaboration request to collaborate with the external user type: creating a sub-workspace in association with the workspace for the external user type, the sub-workspace accessible by an external user associated with the external user type to provide a sub-workspace feedback in respect of one or more digital materials of the plurality of digital materials shared to the sub-workspace; and assigning a sub-workspace user group to the sub-workspace, the sub-workspace user group including at least one external user associated with the external user type and at least one internal user of the one or more internal users to collaborate with the at least one external user; and displaying a set of feedback on the one or more digital materials to a user, the set of feedback including the sub-workspace feedback received via the sub-workspace and a workspace feedback received via the workspace when the user has access to the workspace, and the set of feedback includes only the sub-workspace feedback when the user has access only to the sub-workspace.

In some embodiments, displaying the set of feedback on the one or more digital materials to the user includes determining whether the user is accessing the one or more digital materials via the workspace; and in response to determining the user is accessing the one or more digital materials via the workspace, displaying the workspace feedback and the sub-workspace feedback as the set of feedback, otherwise, displaying only the sub-workspace feedback.

In some embodiments, displaying the set of feedback on the one or more digital materials to the user includes determining whether the user has access to the workspace; and in response to determining the user has access to the workplace, displaying the workspace feedback and the sub-workspace feedback as the set of feedback, otherwise, displaying only the sub-workspace feedback.

In some embodiments, the method includes in response to receiving the external collaboration request with the external user type, automatically sharing at least one digital material from the plurality of digital materials to the sub-workspace based on the external user type.

In some embodiments, the method includes receiving the sub-workspace feedback from an internal user of the one or more internal users assigned to the sub-workspace.

In some embodiments, the external user type includes a service provider type.

In some embodiments, the method includes for each digital material of the plurality of digital materials, storing in a memory the sub-workspace feedback and the workspace feedback in association with that digital material.

In accordance with an example embodiment, there is provided a multi-user collaboration system involving one or more external users. The system includes a memory operable to store a plurality of digital materials to be shared by one or more internal users, a sub-workspace feedback in respect of one or more digital materials of the plurality of digital materials shared to a sub-workspace, and a workspace feedback in respect of the one or more digital materials; and a processor configured to create a workspace to which the plurality of digital materials can be shared by the one or more internal users; receive, from an internal user of the one or more internal users, an external collaboration request to collaborate with an external user type; in response to receiving the external collaboration request to collaborate with the external user type: create a sub-workspace in association with the workspace for the external user type, the sub-workspace accessible by an external user associated with the external user type to provide the sub-workspace feedback in respect of the one or more digital materials shared to the sub-workspace; and assign a sub-workspace user group to the sub-workspace, the sub-workspace user group including one or more external users associated with the external user type and at least one internal user of the one or more internal users to collaborate with the one or more external users; and display a set of feedback on the one or more digital materials to a user, the set of feedback including the sub-workspace feedback received via the sub-workspace and the workspace feedback received via the workspace when the user has access to the workspace, and the set of feedback includes only the sub-workspace feedback when the user has access only to the sub-workspace.

In some embodiments, the processor is configured to determine whether the user is accessing the one or more digital materials via the workspace; and in response to determining the user is accessing the one or more digital materials via the workspace, display the workspace feedback and the sub-workspace feedback as the set of feedback, otherwise, displaying only the sub-workspace feedback.

In some embodiments, the processor is configured to determine whether the user has access to the workspace; and in response to determining the user has access to the workplace, display the workspace feedback and the sub-workspace feedback as the set of feedback, otherwise, display only the sub-workspace feedback.

In some embodiments, the processor is further configured to, in response to receiving the external collaboration request with the external user type, automatically share at least one digital material from the plurality of digital materials to the sub-workspace based on the external user type.

In some embodiments, the processor is configured to create one or more sub-workspaces for the external user type, each sub-workspace of the one or more sub-workspace being associated with a different external user associated with the external user type, and each different external user having access only to the sub-workspace feedback provided within the sub-workspace to which that different external user has access.

In some embodiments, the processor is configured to receive the sub-workspace feedback from an internal user of the one or more internal users assigned to the sub-workspace.

In some embodiments, the external user type includes a service provider type.

In some embodiments, the processor is configured to, for each digital material of the plurality of digital materials, store in the memory the sub-workspace feedback and the workspace feedback in association with that digital material.

In accordance with an example embodiment, there is provided a method of providing a multi-user collaboration system involving one or more external users. The method includes creating a workspace to which a plurality of digital materials can be shared by one or more internal users; creating one or more sub-workspaces in association with the workspace for one or more corresponding external user types, each sub-workspace accessible by an external user associated with a corresponding external user type to provide a sub-workspace feedback in respect of one or more digital materials of the plurality of digital materials shared to that sub-workspace; automatically assigning a user to one or more of the workspace and the one or more sub-workspace based on one or more user attributes of the user; and displaying a set of feedback on the one or more digital materials to the user, the set of feedback including the sub-workspace feedback received via the one or more sub-workspaces and a workspace feedback received via the workspace when the user has access to the workspace, and the set of feedback includes only the sub-workspace feedback received via the one or more sub-workspaces to which the user has access.

In some embodiments, automatically assigning the user to the one or more of the workspace and the one or more sub-workspaces includes identifying the one or more of the workspace and the one or more sub-workspaces for the user by determining whether the one or more user attributes of the user satisfy a workspace identifier assigned to each of the workspace and the one or more sub-workspaces.

In some embodiments, displaying the set of feedback on the one or more digital materials to the user includes determining whether the user is accessing the one or more digital materials via the workspace; and in response to determining the user is accessing the one or more digital materials via the workspace, displaying the workspace feedback and the sub-workspace feedback as the set of feedback, otherwise, displaying only the sub-workspace feedback.

In some embodiments, displaying the set of feedback on the one or more digital materials to the user includes determining whether the user has access to the workspace; and in response to determining the user has access to the workplace, displaying the workspace feedback and the sub-workspace feedback as the set of feedback, otherwise, displaying only the sub-workspace feedback.

In some embodiments, creating the one or more sub-workspaces in association with the workspace for the one or more corresponding external user types includes automatically sharing at least one digital material from the plurality of digital materials to the one or more sub-workspace based on the one or more corresponding external user type.

In some embodiments, the one or more sub-workspaces includes at least two sub-workspaces created for the same external user type, and the method further includes automatically assigning two different external users associated with the same external user type to the at least two sub-workspaces, each different external user having access only to the sub-workspace feedback provided within the sub-workspace to which that different external user has access.

In some embodiments, the one or more corresponding external user types include a service provider type.

In some embodiments, the method includes for each digital material of the plurality of digital materials, storing in a memory the sub-workspace feedback and the workspace feedback in association with that digital material.

In accordance with an example embodiment, there is provided a multi-user collaboration system involving one or more external users. The multi-user collaboration system includes a memory operable to store a plurality of digital materials to be shared by one or more internal users, a sub-workspace feedback in respect of one or more digital materials of the plurality of digital materials shared to a sub-workspace, and a workspace feedback in respect of the one or more digital materials; and a processor configured to: create a workspace to which the plurality of digital materials can be shared by one or more internal users; create one or more sub-workspaces in association with the workspace for one or more corresponding external user types, each sub-workspace accessible by an external user associated with a corresponding external user type to provide the sub-workspace feedback in respect of the one or more digital materials shared to that sub-workspace; automatically assign a user to one or more of the workspace and the one or more sub-workspace based on one or more user attributes of the user; and display a set of feedback on the one or more digital materials to the user, the set of feedback including the sub-workspace feedback received via the one or more sub-workspaces and the workspace feedback received via the workspace when the user has access to the workspace, and the set of feedback includes only the sub-workspace feedback received via the one or more sub-workspaces to which the user has access.

In some embodiments, the processor is configured to identify the one or more of the workspace and the one or more sub-workspaces for the user by determining whether the one or more user attributes of the user satisfy a workspace identifier assigned to each of the workspace and the one or more sub-workspaces.

In some embodiments, the processor is configured to determine whether the user is accessing the one or more digital materials via the workspace; and in response to determining the user is accessing the one or more digital materials via the workspace, display the workspace feedback and the sub-workspace feedback as the set of feedback, otherwise, display only the sub-workspace feedback.

In some embodiments, the processor is configured to determine whether the user has access to the workspace; and in response to determining the user has access to the workplace, display the workspace feedback and the sub-workspace feedback as the set of feedback, otherwise, display only the sub-workspace feedback.

In some embodiments, the processor is configured to automatically share at least one digital material from the plurality of digital materials to the one or more sub-workspace based on the one or more corresponding external user type.

In some embodiments, the one or more sub-workspaces includes at least two sub-workspaces created for the same external user type, and the processor is further configured to automatically assign two different external users associated with the same external user type to the at least two sub-workspaces, each different external user having access only to the sub-workspace feedback provided within the sub-workspace to which that different external user has access.

In some embodiments, the one or more corresponding external user types include a service provider type.

In some embodiments, the processor is configured to, for each digital material of the plurality of digital materials, store in the memory the sub-workspace feedback and the workspace feedback in association with that digital material.

In accordance with an example embodiment, there is provided a method of providing a multi-user collaboration system involving one or more external users. The method includes creating a workspace to which a plurality of digital materials can be shared by one or more internal users; creating a sub-workspace in association with the workspace for an external user type, the sub-workspace accessible by an external user associated with the external user type to provide a sub-workspace feedback in respect of one or more digital materials of the plurality of digital materials shared to the sub-workspace; receiving the sub-workspace feedback in respect of the one or more digital materials via the sub-workspace; receiving a workspace feedback in respect of the one or more digital materials via the workspace; and displaying a set of feedback on the one or more digital materials to a user, the set of feedback including the sub-workspace feedback received via the sub-workspace and the workspace feedback received via the workspace when the user has access to the workspace, and the set of feedback includes only the sub-workspace feedback when the user has access only to the sub-workspace.

In some embodiments, displaying the set of feedback on the one or more digital materials to the user includes determining whether the user is accessing the one or more digital materials via the workspace; and in response to determining the user is accessing the one or more digital materials via the workspace, displaying the workspace feedback and the sub-workspace feedback as the set of feedback, otherwise, displaying only the sub-workspace feedback.

In some embodiments, displaying the set of feedback on the one or more digital materials to the user includes determining whether the user has access to the workspace; and in response to determining the user has access to the workplace, displaying the workspace feedback and the sub-workspace feedback as the set of feedback, otherwise, displaying only the sub-workspace feedback.

In some embodiments, for each sub-workspace feedback, providing a workspace discussion for receiving one or more workspace discussion entries from the one or more internal users and a sub-workspace discussion for receiving one or more sub-workspace discussion entries from at least the external user associated with the sub-workspace.

In some embodiments, displaying the set of feedback on the one or more digital materials to the user includes: displaying the sub-workspace feedback, the sub-workspace discussion and the workspace discussion associated with each sub-workspace feedback, and the workspace feedback received via the workspace when the user has access to the workspace, otherwise, displaying only the sub-workspace feedback and the sub-workspace discussion associated with each sub-workspace feedback when the user has access only to the sub-workspace.

In some embodiments, creating the sub-workspace in association with the workspace for the external user type includes creating one or more sub-workspaces for the external user type, each sub-workspace of the one or more sub-workspace being associated with a different external user associated with the external user type, and each different external user having access only to the sub-workspace feedback provided within the sub-workspace to which that different external user has access.

In some embodiments, the method includes receiving the sub-workspace feedback from an internal user of the one or more internal users assigned to the sub-workspace.

In some embodiments, the external user type includes a service provider type.

In some embodiments, the method includes for each digital material of the plurality of digital materials, storing in a memory the sub-workspace feedback and the workspace feedback in association with that digital material.

In accordance with an example embodiment, there is provided a multi-user collaboration system involving one or more external users. The multi-user collaboration system includes a memory operable to store a plurality of digital materials to be shared by one or more internal users, a sub-workspace feedback in respect of one or more digital materials of the plurality of digital materials shared to a sub-workspace, and a workspace feedback in respect of the one or more digital materials; and a processor configured to: create a workspace to which the plurality of digital materials can be shared by the one or more internal users; create a sub-workspace in association with the workspace for an external user type, the sub-workspace accessible by an external user associated with the external user type to provide a sub-workspace feedback in respect of the one or more digital materials shared to the sub-workspace; receive the sub-workspace feedback in respect of the one or more digital materials via the sub-workspace; receive a workspace feedback in respect of the one or more digital materials via the workspace; and display a set of feedback on the one or more digital materials to a user, the set of feedback including the sub-workspace feedback received via the sub-workspace and the workspace feedback received via the workspace when the user has access to the workspace, and the set of feedback includes only the sub-workspace feedback when the user has access only to the sub-workspace.

In some embodiments, the processor is configured to determine whether the user is accessing the one or more digital materials via the workspace; and in response to determining the user is accessing the one or more digital materials via the workspace, display the workspace feedback and the sub-workspace feedback as the set of feedback, otherwise, display only the sub-workspace feedback.

In some embodiments, the processor is configured to determine whether the user has access to the workspace; and in response to determining the user has access to the workplace, display the workspace feedback and the sub-workspace feedback as the set of feedback, otherwise, display only the sub-workspace feedback.

In some embodiments, the processor is configured to, for each sub-workspace feedback, provide a workspace discussion for receiving one or more workspace discussion entries from the one or more internal users and a sub-workspace discussion for receiving one or more sub-workspace discussion entries from at least the external user associated with the sub-workspace.

In some embodiments, the processor is configured to display the set of feedback comprising the sub-workspace feedback, the sub-workspace discussion and the workspace discussion associated with each sub-workspace feedback, and the workspace feedback received via the workspace when the user has access to the workspace, otherwise, to display the set of feedback including only the sub-workspace feedback and the sub-workspace discussion associated with each sub-workspace feedback when the user has access only to the sub-workspace.

In some embodiments, the processor is configured to create one or more sub-workspaces for the external user type, each sub-workspace of the one or more sub-workspace being associated with a different external user associated with the external user type, and each different external user having access only to the sub-workspace feedback provided within the sub-workspace to which that different external user has access.

In some embodiments, the processor is configured to receive the sub-workspace feedback from an internal user of the one or more internal users assigned to the sub-workspace.

In some embodiments, the external user type includes a service provider type.

In some embodiments, the processor is configured to, for each digital material of the plurality of digital materials, store in the memory the sub-workspace feedback and the workspace feedback in association with that digital material.

In accordance with an example embodiment, there is provided a monitoring system for detecting an unauthorized distribution of a digital material obtained from a multi-user collaboration system. The monitoring system includes at least one processor configured to: determine a set of identifying data associated with the digital material; obtain relevant source data from one or more data sources external to the multi-user collaboration system based on the set of identifying data; extract identifiable source data from the relevant source data based on the set of identifying data; compare at least one portion of the extracted identifiable source data and at least one portion of the set of identifying data; and in response to identifying a sufficient match between the extracted identifiable source data and the set of identifying data, generate a notification alerting of the unauthorized distribution of the digital material.

In some embodiments, the at least one processor is configured to generate at least one portion of the set of identifying data.

In some embodiments, the at least one processor is further configured to: generate a confidence score based on the comparison of the at least one portion of the extracted identifiable source data and the at least one portion of the set of identifying data; and generate the notification based on the confidence score.

In some embodiments, the at least one processor is configured to identify in the notification an unauthorized location of the digital material.

In some embodiments, the at least one processor is configured to: determine a recommendation for addressing the authorized distribution of the digital material; and generating the notification to comprise the recommendation.

In accordance with an example embodiment, there is provided a method for detecting an unauthorized distribution of a digital material obtained from a multi-user collaboration system. The method involves operating at least one processor to determine a set of identifying data associated with the digital material; obtain relevant source data from one or more data sources external to the multi-user collaboration system based on the set of identifying data; extract identifiable source data from the source data; compare at least one portion of the extracted identifiable source data and at least one portion of the set of identifying data; and in response to identifying a sufficient match between the extracted identifiable source data and the set of identifying data, generate a notification alerting of the unauthorized distribution of the digital material.

In some embodiments, the method involves operating the at least one processor to generate at least one portion of the set of identifying data.

In some embodiments, the method involves operating the at least one processor to: generate a confidence score based on the comparison of the at least one portion of the extracted identifiable source data and the at least one portion of the set of identifying data; and generating the notification based on the confidence score.

In some embodiments, generating the notification comprises identifying in the notification an unauthorized location of the digital material.

In some embodiments, generating the notification comprises: determining a recommendation for addressing the authorized distribution of the digital material; and generating the notification to comprise the recommendation.

### BRIEF DESCRIPTION OF THE DRAWINGS

Several embodiments will now be described in detail with reference to the drawings, in which:

FIG. 1 is a block diagram of components interacting with a multi-user collaboration system in accordance with an example embodiment;

FIG. 2 is a block diagram of an external data management system interacting with the multi-user collaboration system of FIG. 1, in accordance with an example embodiment;

FIG. 3 is a flowchart of an example embodiment of providing a multi-user collaboration system;

FIG. 4A is an illustration of an example workspace via which an example digital material is accessed in accordance with an example embodiment;

FIG. 4B is an illustration of an example sub-workspace via which the example digital material shown in FIG. 4A is accessed;

FIG. 4C is an illustration of an example sub-workspace via which the example digital material shown in FIG. 4A is accessed;

FIG. 5A is an illustration of the example workspace of FIG. 4A in accordance with another example embodiment;

FIG. 5B is an illustration of the example sub-workspace of FIG. 4B in accordance with another example embodiment;

FIG. 5C is an illustration of the example sub-workspace of FIG. 4C in accordance with another example embodiment;

FIG. 6 is a screenshot of an example workspace in accordance with an example embodiment;

FIG. 7 is a screenshot of an example sub-workspace in accordance with an example embodiment;

FIG. 8 is a screenshot of a digital material accessed via a sub-workspace in accordance with an example embodiment;

FIG. 9A is a screenshot of the digital material shown in FIG. 8 accessed via an example workspace in accordance with an example embodiment;

FIG. 9B is a screenshot of the digital material shown in FIG. 8 accessed via another example embodiment of the workspace shown in FIG. 9A;

FIG. 9C is a screenshot of the digital material shown in FIG. 8 accessed via another example embodiment of the workspace shown in FIG. 9A;

FIG. 10 is a screenshot of an example feedback search interface in accordance with an example embodiment;

FIG. 11 is a flowchart of an example embodiment of providing a multi-user collaboration system;

FIG. 12 is a flowchart of an example embodiment of providing a multi-user collaboration system;

FIG. 13 is a block diagram of an example access monitoring system;

FIG. 14A is a flowchart of an example method of operating the access monitoring system of FIG. 13;

FIG. 14B is a flowchart of another example method for operating the access monitoring system of FIG. 13;

FIG. 14C is a flowchart of another example method for operating the access monitoring system of FIG. 13;

FIG. 14D is a flowchart of another example method for operating the access monitoring system of FIG. 13;

FIG. 14E is a flowchart of another example method for operating the access monitoring system of FIG. 13; and

FIG. 14F is a flowchart of another example method for operating the access monitoring system of FIG. 13.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

When different parties work together on a project, online collaboration systems can help to increase the efficiency in which that project can be completed, as well as help to improve the collaboration process overall. Online collaboration systems enable parties to work together without any restrictions on geographical locations, which can expand partnership opportunities. As remote workplaces become increasingly commonplace, online collaboration systems can also become crucial for collaboration within organizations as well.

Parties within an organization can benefit from an online collaboration system that can manage the digital materials and any feedback received from the various individuals involved with the project and/or tasks within the project. It can be challenging for parties who are part of different entities, such as an internal entity and an external entity, to collaborate on projects together. Due to network security restrictions, local network security of each entity can limit the extent to which the entities can easily collaborate on the digital materials together. Generally, outside of collaboration systems, different entities collaborate by sharing versions of the digital material back-and-forth between the parties. This can be a disconnected and duplicated process. As a result, there can be challenges in tracking between the various versions of the digital material, and as well as the feedback received from any of the individuals involved on either side of the collaboration process. Existing systems can result in various issues, including duplicate comments, missed feedback, and series workflows.

Further, even on existing data/document management system, collaborations between internal and external entities require proper security and access management. Generally, the digital materials requiring review by the external entities may include elements that should not be shared with the external entities. Also, the engaging entity may be working with multiple different external entities of the same type to obtain design feedback, such as cost estimates and/or proposals on the project outlined on the same digital material, and so, those external entities should not have access to the feedback received from the other external entities.

The extent of a collaboration between the different entities may vary in range—from simply a short review of a digital material (e.g., requests for cost estimates and/or requests for proposal (RFPs)) to an extensive, long-term design partnership involving detailed discussion and multiple revisions of the designs being shared between the entities, for example. Whatever the type of collaborations these are, it can be difficult to manage these collaborations when multiple individuals are involved at either the engaging entity (or internal entity) and the external entity. The management of the digital materials can be even more difficult when multiple documents, or versions of documents, are being shared between the internal and external entities. This can be even more difficult when both the internal and external entities are required to provide feedback on the digital materials, some of which may require review by the other entity and some which may not.

The various embodiments described herein generally relate to multi-user collaboration systems involving one or more external users (and methods for providing the multi-user collaboration systems). The methods involve creating a workspace to which digital materials can be shared by one or more internal users, and creating a sub-workspace in association with the workspace for an external user type. The sub-workspace can be accessible by an external user associated with the external user type to provide a sub-workspace feedback in respect of the digital materials shared to the sub-workspace. The multi-user collaboration systems described herein can receive the sub-workspace feedback in respect of the digital material(s) via the sub-workspace, and a workspace feedback in respect of the digital material(s) via the workspace. Depending on the access assigned to a user, the multi-user collaboration system can vary the set of feedback displayed to that user. For example, when a user has access to the workspace, the multi-user collaboration system displays the sub-workspace feedback received via the sub-workspace and the workspace feedback received via the workspace. Alternatively, when the user has access only to a sub-workspace, the multi-user collaboration system displays only the sub-workspace feedback to that user. As a result, the multi-user collaboration systems described herein can result in seamless collaborations between internal and external entities on digital materials at the same time.

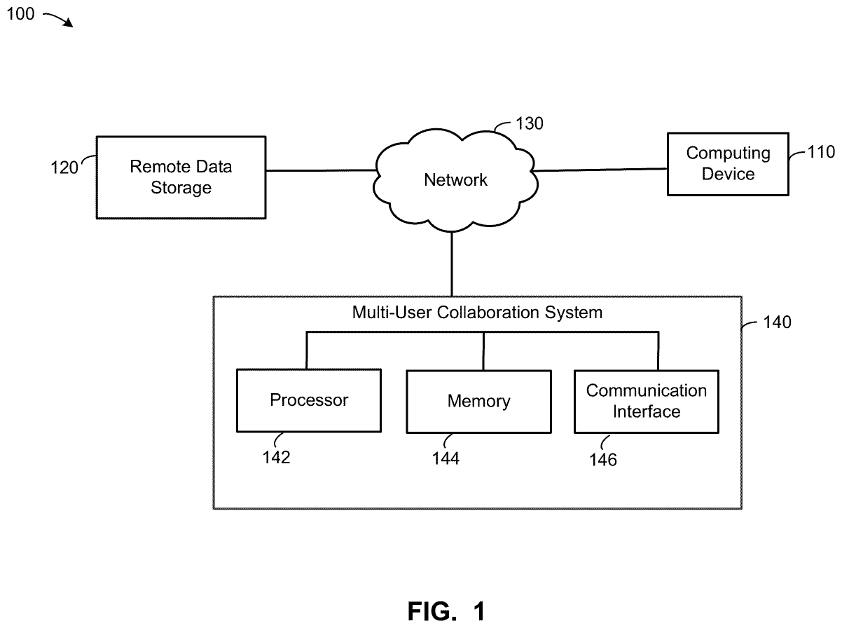

Reference is first made to FIG. 1, which illustrates a block diagram 100 of components interacting with a multi-user collaboration system 140. As shown in FIG. 1, the multi-user collaboration system 140 can be in communication with a computing device 110 and a remote data storage 120 via a network 130.

The multi-user collaboration system 140 includes a processor 142, a memory 144 and a communication interface 146. The processor 142, the memory 144 and the communication interface 146 may be implemented in software or hardware, or a combination of software and hardware. The processor 142, the memory 144 and the communication interface 146 can be combined into fewer number of components or may be separated into further components. The multi-user collaboration system 140 may, in some embodiments, be split into multiple computing systems that may be distributed over a wide geographic area and connected via the network 130.

The processor 142 is configured to control the operation of the multi-user collaboration system 140. The processor 142 may be any suitable processors, controllers or digital signal processors that can provide sufficient processing power depending on the configuration, purposes and requirements of the multi-user collaboration system 140. In some embodiments, the processor 142 can include more than one processor with each processor being configured to perform different dedicated tasks. For example, the processor 142 can create the workspace and one or more sub-workspaces in association with the workspace. The processor 142 can then receive feedback via the workspace and/or the sub-workspaces.

The memory 144 can include RAM, ROM, one or more hard drives, one or more flash drives or some other suitable data storage elements such as disk drives, etc. For example, the memory 144 can store digital materials that can be shared by internal users to the workspace and/or sub-workspaces. The memory 144 can also store the sub-workspace feedback received in respect of the digital material(s) shared to a sub-workspace, and the workspace feedback received in respect of the digital material(s). The processor 142 can store the workspace feedback in the memory 144 in association with the workspace, and the sub-workspace feedback in association with the sub-workspace. The workspace feedback and sub-workspace feedback can vary in substance, such as, for example and not of limitation, text, markings, edits to the content of the digital material, icons (e.g., emotion icons), request for further edits/review, assignment of task to users, approvals or rejections of certain edits or suggestions, etc. The memory 144 can store data in respect of the users, such as user attributes, user profiles, user access level, user roles within the entity engaging the multi-user collaboration system 140, etc. The memory 144 can, in some embodiments, store metadata related to the digital materials, such as but not limited to, identification data of digital materials shared to a workspace, credentials required for accessing data sources to which the digital materials may be shared without authorization and data collected by a data collector collecting data to identify digital materials shared without authorization.

The communication interface 146 may be any interface that enables the multi-user collaboration system 140 to communicate with other devices and systems. The communication interface 146 may also include at least one of an Internet, Local Area Network (LAN), Ethernet, Firewire, modem or digital subscriber line connection. Various combinations of these elements may be incorporated within the communication interface 146. For example, the communication interface 146 may receive input from various input devices, such as a mouse, a keyboard, a touch screen, a thumbwheel, a track-pad, a track-ball, a card-reader, voice recognition software and the like depending on the requirements and implementation of the multi-user collaboration system 140.

The remote data storage 120 can include one or more processors with computing processing abilities and memory such as a database(s) or file system(s). Although only one remote data storage 120 is shown for ease of exposition, there may be multiple remote data storage 120 distributed over a wide geographic area and connected via network 130. The remote data storage 120 can be used to store back-up data in some embodiments, and/or data less frequently accessed by the multi-user collaboration system 140. For example, the remote data storage 120 can store data related to completed projects and/or inactive users.

The computing device 110 may be any networked device operable to connect to the network 130. A networked device is a device capable of communicating with other devices through a network such as the network 130. A networked device may couple to the network 130 through a wired or wireless connection. As noted, these computing devices 110 may include at least a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

Although only one computing device 110 is shown in FIG. 1, it will be understood that more than one computing device 110 can communicate with the multi-user collaboration system 140 at any one time. The computing device 110 can be used by an external user or an internal user to access the multi-user collaboration system 140. In some embodiments, a connection request initiated from the computing device 110 may be initiated from a web browser and directed at the browser-based communications application on the multi-user collaboration system 140.

The network 130 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between the multi-user collaboration system 140, the computing device 110 and the remote data storage 120.

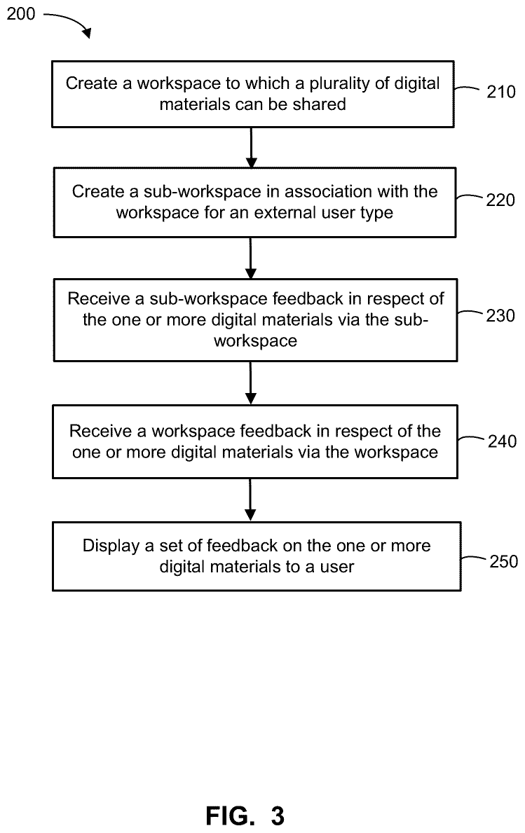

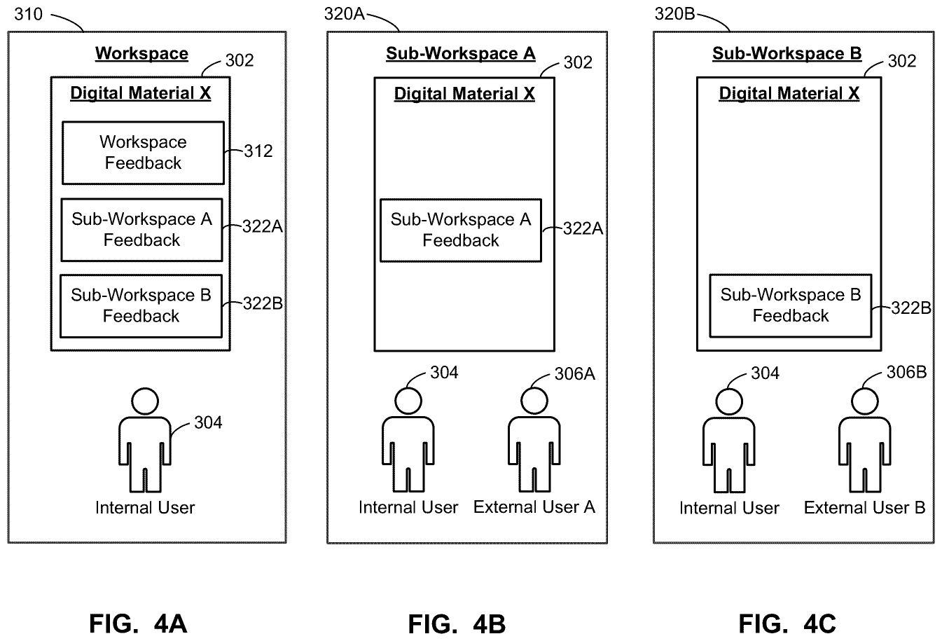

Referring now to FIG. 3, which shows a flowchart of an example method 200 for providing the multi-user collaboration system 140. To illustrate the method 200, reference will be made to FIGS. 4A to 10.

At 210, the processor 142 creates a workspace to which a plurality of digital materials can be shared by one or more internal users.

FIG. 4A is an illustration of an example workspace 310 via which an example digital material 302 is accessed by an internal user 304.

The workspace 310 is an electronic environment to which the digital material(s) 302 can be shared by the internal users 304, and in respect of which users with the associated access level can provide feedback.

The internal users 304 can include various types of users, including administrative users within an organization who manage the operation of the multi-user collaboration system 140 and may not necessarily be involved with the collaboration process taking place via the workspace 310, and collaboration users within the organization who are participating in the collaboration process. The administrative users and/or the collaboration users can share digital materials 302 to the workspace 310.

The digital materials 302 can include, but are not limited to, documents, drawings, photographs, CAD models, etc. In some embodiments, the multi-user collaboration system 140 can present the digital materials 302 for review via the workspace 310 and receive feedback directly in respect of the digital material 302 via the workspace 310. For example, the multi-user collaboration system 140 can present the digital material 302 in a file format that does not allow edits to be made to the content of the digital material 302. Instead, the multi-user collaboration system 140 can receive feedback in respect of the digital material 302 generally and/or in respect of specific portions of the content of the digital material 302. The feedback can then be stored by the multi-user collaboration system 140 in association with the digital material 302. That is, the multi-user collaboration system 140 does not store different versions of the digital material 302 based on the type of feedback received. For example, FIG. 4A shows that the digital material 302 is associated with a workspace feedback 312, a sub-workspace feedback 322A and a sub-workspace feedback 322B, whereas, in FIG. 4B, the digital material 302 is associated only with the sub-workspace feedback 322A.

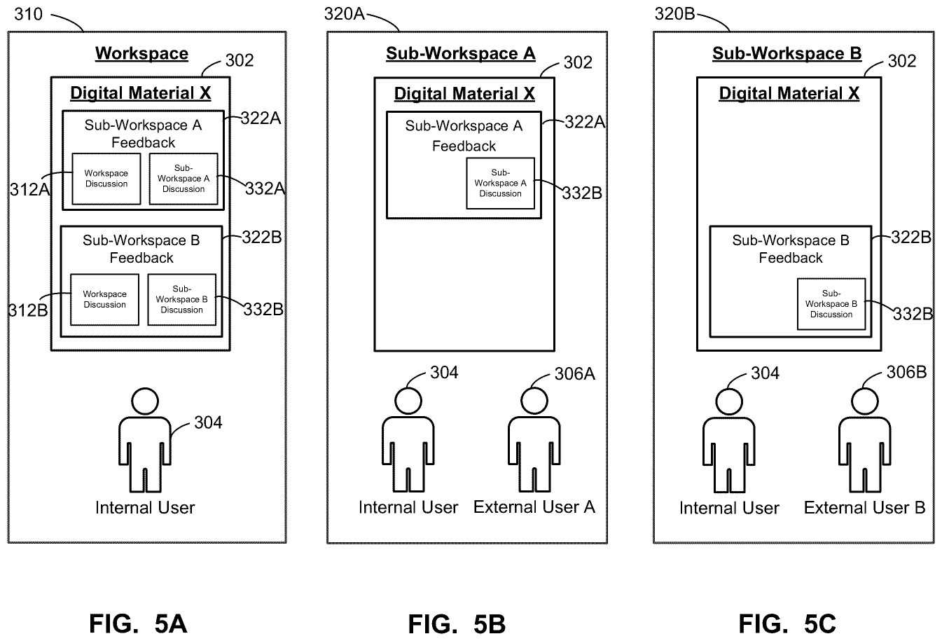

In some embodiments, each feedback can be associated with a workspace discussion and a sub-workspace discussion. FIGS. 5A to 5C illustrate examples of the various workspace discussion and sub-workspace discussion. In FIG. 5B, the multi-user collaboration system 140 receives the sub-workspace feedback 322A. From the sub-workspace 320A, the sub-workspace users 304 and 306A can access the sub-workspace discussion 332B in respect of the sub-workspace feedback 322A. For the sub-workspace user 304 who is also the internal user 304 with access to the workspace 310, the sub-workspace user 304 can, in some embodiments, also view, access, and/or contribute to the related workspace discussion 312A. At the workspace 310 (as seen in FIG. 5A), the multi-user collaboration system 140 can provide the internal user 304 with a workspace discussion 312A and the sub-workspace discussion 332B in respect of the sub-workspace feedback 322A. Similarly, the multi-user collaboration system 140 can provide a sub-workspace discussion 332B in respect of the sub-workspace feedback 322B via the sub-workspace 320 (FIG. 5C), and the multi-user collaboration system 140 can provide a workspace discussion 312B and the sub-workspace discussion 332B in respect of the sub-workspace feedback 322B via the workspace 310.

In some embodiments, the multi-user collaboration system 140 can share a workspace feedback to the sub-workspace(s) 320. The multi-user collaboration system 140 can then provide a workspace discussion and a sub-workspace discussion for that workspace feedback. Each sub-workspace 320 will be associated with a separate sub-workspace discussion.

In some embodiments, the multi-user collaboration system 140 can present the digital material 302 in a file format and/or with an application that allows direct edit and/or interaction with the content of the digital material 302. For example, the multi-user collaboration system 140 can present a CAD model via the workspace 310 and/or the sub-workspace (as will be described with reference to FIGS. 4B and 4C) to enable the users to manipulate and/or edit the CAD model.

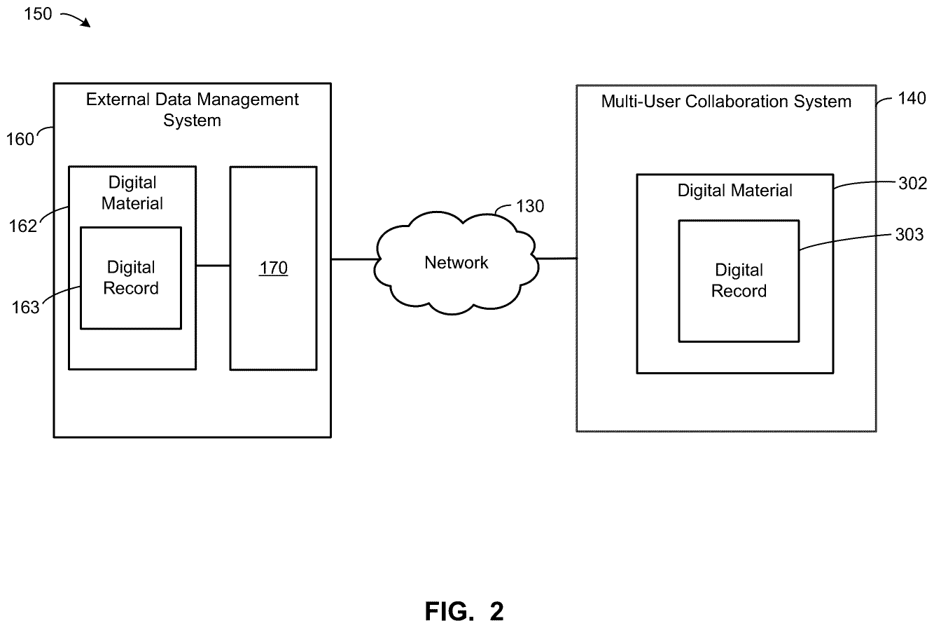

In some embodiments, the multi-user collaboration system 140 can share digital material(s) 302 provided via a data management application for maintaining a digital record of the digital material 302. For example, FIG. 2 illustrates generally at 150 an example external data management system 160 in communication with the multi-user collaboration system 140. The external data management system 160 can act as an enterprise data management system and/or a lifecycle management system. The external data management system 160 can include a data management application 170 that can interface with the multi-collaboration system 140. The data management application 170 can be in communication with the multi-user collaboration system 140 via the network 130. When the multi-user collaboration system 140 shares the digital material 302 via the data management application 170, the data management application 170 can associate a digital record 303 with that digital material 302. The digital record 303 can include a digital material identifier to that digital material 302 and a version identifier consistent with that of the external data management system 160 from which the digital material 302 was provided. That is, the digital record 163 stored in association with the digital material 162 stored at the external data management system 160 is consistent with the digital record 303 associated with the digital material 302 stored at the multi-user collaboration system 140.

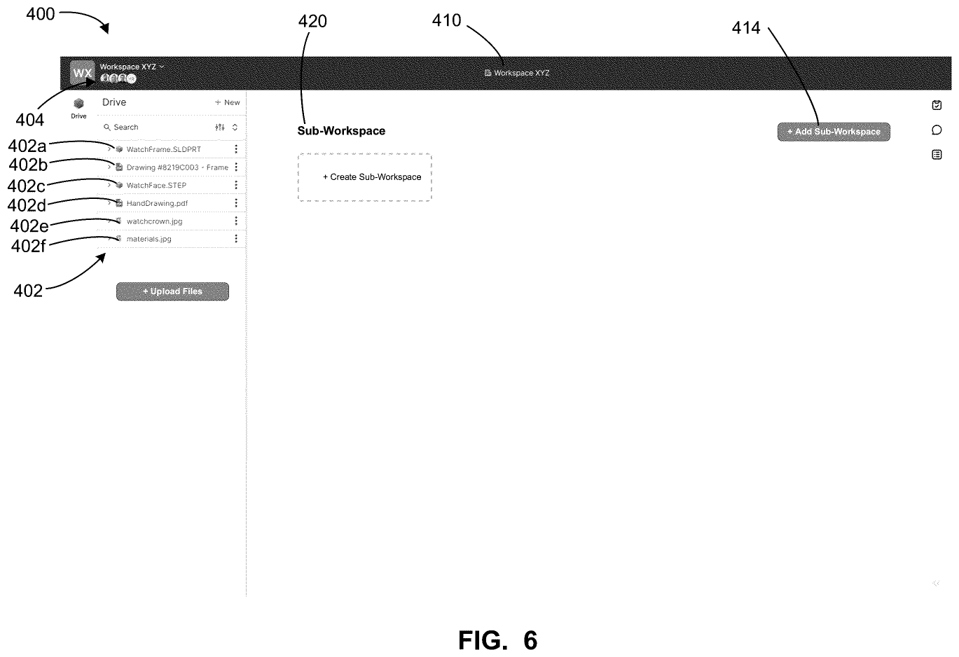

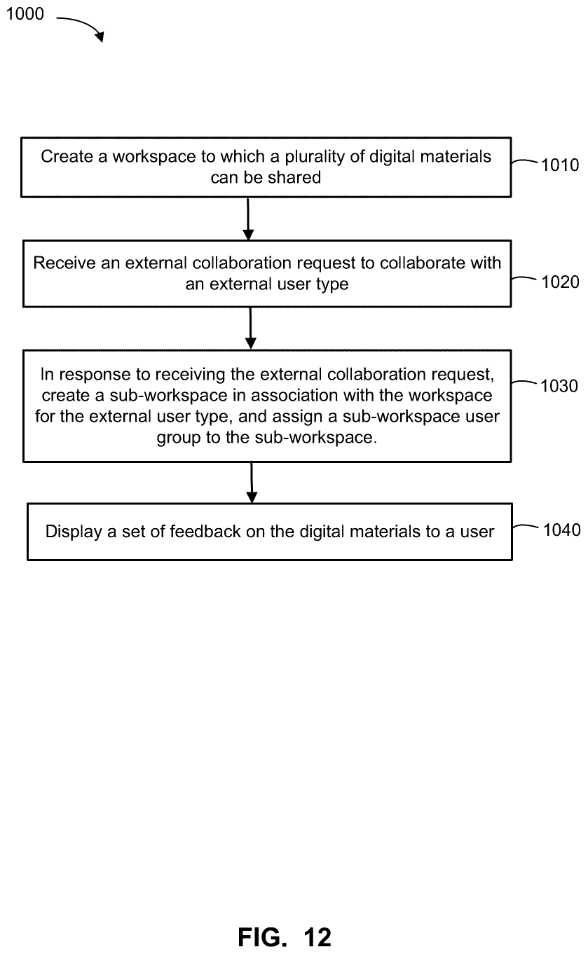

FIG. 6 is a screenshot 400 of an example workspace 410 (“Workspace XYZ”). Internal users (generally shown at 404) have access to the workspace 410. As can be seen, a set of digital materials 402 (namely 402a to 402f) has been shared to the workspace 410 and can be accessed by the internal users 404. The internal users 404 can add digital materials 402 to the workspace 410. The internal users 404 can also create sub-workspace(s) 420. In the example of FIG. 6, the multi-user collaboration system 140 can be initiated by the internal user(s) 404 to create a sub-workspace 420 when a create sub-workspace button 414 is selected. Other interface components may similarly be provided for this purpose. As will be described with reference to FIG. 12, in some embodiments, the multi-user collaboration system 140 may be automatically prompted to create certain sub-workspaces 420 in response to a collaboration request received from the internal user(s) 404.

At 220, the processor 142 creates a sub-workspace in association with the workspace 410 for an external user type.

The external user type identifies a type or group of external users based on various characteristics, such as a functionality or service they may offer. For example, and not of limitation, an external user type can include a service provider type (e.g., external designer, specialist for responding to a request for proposal, manufacturer, supplier, vendor, etc.) or a customer type engaging the services of the internal users 304. In some embodiments, an external user type can include an internal user group with limited access to the feedback and/or digital materials 302 shared to the sub-workspace.

FIGS. 4B and 4C are illustrations of example sub-workspaces 320 (namely 320A and 320B, respectively). The sub-workspace 320 can be referred to as a portal in some embodiments. Similar to the workspace 310, the sub-workspace 320 is an electronic environment to which the digital material(s) 302 can be shared by the internal users 404 from the workspace 310. Unlike the workspace 310, the multi-user collaboration system 140 will not provide access to the digital material(s) 302 and feedback received via the workspace 310 and the other sub-workspace(s) 320 to those with access only to the sub-workspace 320. The external user(s) 306 can, in some embodiments, add digital materials to the sub-workspace 320 to which they have access.

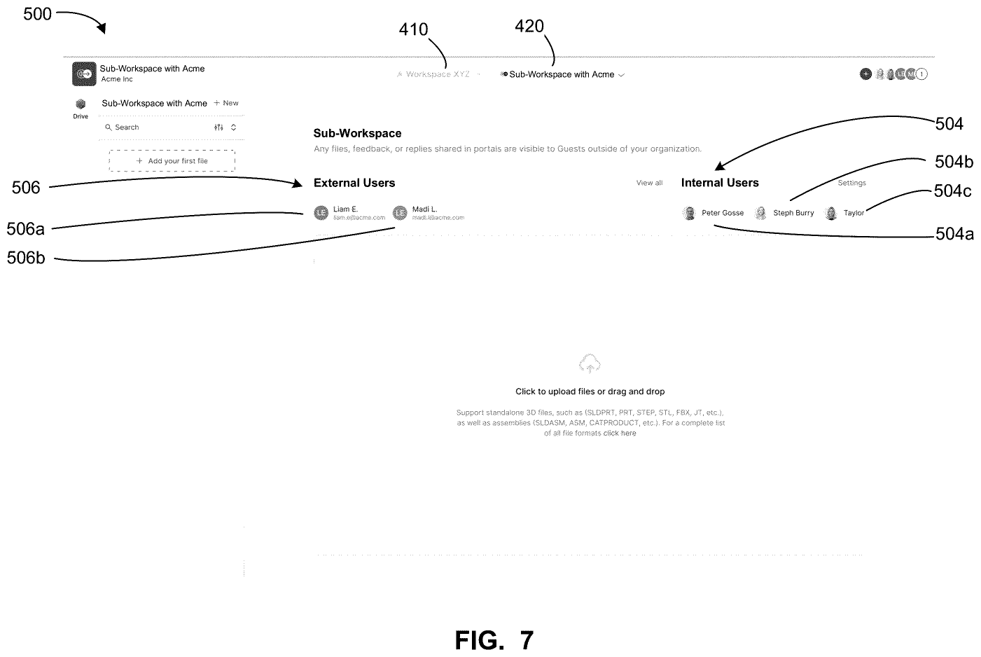

FIG. 7 is a screenshot 500 of an example sub-workspace 420 created in association with the workspace 410 shown in FIG. 6. When the sub-workspace 420 is created in association with the workspace 410, the multi-user collaboration system 140 can automatically assign the internal users 404 to each sub-workspace 420. Also, when digital materials are shared to the sub-workspace 420, the multi-user collaboration system 140 automatically adds that new digital material to the workspace 410. The multi-user collaboration system 140 can then receive workspace feedback 312 in respect of the new digital materials—that is, the workspace feedback 312 will not be available to the external entity that had shared that new digital material unless that workspace feedback 312 is shared to the sub-workspace 420 of that external entity. In some embodiments, the multi-user collaboration system 140 may identify a subset of the internal users 404 to assign to the sub-workspace 420. For example, for the sub-workspace 420 shown in FIG. 7, the multi-user collaboration system 140 has assigned the internal users 504 (namely internal users 504a, 504b, and 504c) from the internal users 404 of the workspace 410 to collaborate with the external users 506 assigned to the sub-workspace 420, namely external users 506a and 506b.

The sub-workspace 320 is accessible by an external user 306 associated with the external user type to provide a sub-workspace feedback 322 in respect of the digital material(s) 302 shared to the sub-workspace 320. As shown in FIG. 4B, the multi-user collaboration system 140 can receive the sub-workspace feedback 322A in respect of the digital material 302 via the sub-workspace 320A. The multi-user collaboration system 140, as shown in FIG. 4C, can receive the sub-workspace feedback 322B in respect of the digital material 302 via the sub-workspace 320B. The multi-user collaboration system 140 stores the sub-workspace feedback 322A and the sub-workspace feedback 322B in the memory 144 in association with the digital material 302. When the external user 306A accesses the digital material 302, the multi-user collaboration system 140 will only display to the external user 306A the sub-workspace feedback 322A with the digital material 302. Similarly, when the external user 306B accesses the digital material 302, the multi-user collaboration system 140 will only display to the external user 306B the sub-workspace feedback 322B with the digital material 302. The external users 306A and 306B will not have access to the sub-workspace feedbacks 322B and 322A that the other had submitted via the assigned sub-workspace 320B and 320A respectively. In contrast, as shown in FIG. 4A, the multi-user collaboration system 140 can display to the internal user 304 the workspace feedback 312 and the sub-workspace feedbacks 322A and 322B as the internal user 304 has access to the workspace 310, and the sub-workspaces 320A and 320B. In some embodiments, the multi-user collaboration system 140 can automatically assign an internal user 304 with access to the workspace 310 access to all the sub-workspaces 320 created in association with that workspace 310.

In some embodiments, the multi-user collaboration system 140 can create multiple sub-workspaces 320 for the same external user type but different external users 306. For example, the multi-user collaboration system 140 would assign the sub-workspace 302A to the external user 306A and the sub-workspace 302B to the external user 306B. The external users 306A and 306B can be associated with the same external user type. For example, when the internal user 304 is undergoing a Request for Proposal (RFP) process to obtain cost estimates for a task in a project (e.g., a gear system design in a watch), the multi-user collaboration system 140 can receive from the internal user 304 a request to collaborate with several different external users 306 who can complete that task to obtain cost estimates. The multi-user collaboration system 140 can then create the sub-workspaces 320 for the same external user type (e.g., a gear system designer) but each sub-workspace 320 would be for a different external user 306 to obtain feedback from each of those different external users 306 independently.

In some embodiments, the multi-user collaboration system 140 can create the sub-workspace 320 for two or more different external user types. For example, in a windshield wiper manufacturing project, the multi-user collaboration system 140 can determine that the external user type necessary can include a manufacturer user, a glass vendor user, and an assembly plant user.

At 230, the processor 142 receives the sub-workspace feedback 322 in respect of the digital materials 302 via the sub-workspace 320.

The multi-user collaboration system 140 can receive the sub-workspace feedback 322 from an internal user 304 and/or the external user 306.

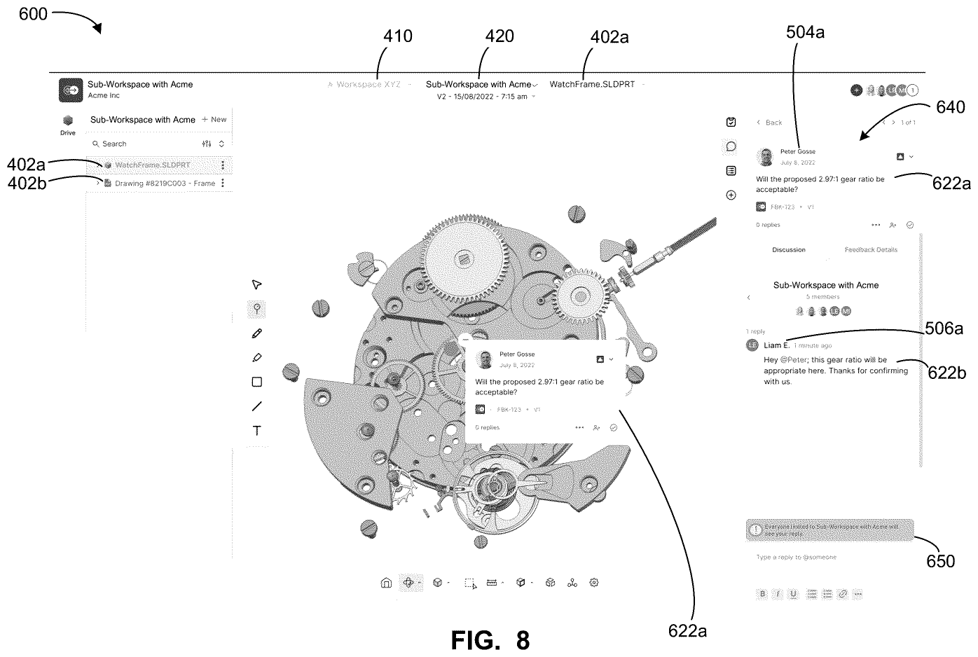

FIG. 8 is a screenshot 600 of a digital material 402a accessed via the sub-workspace 420. As shown, the internal users 504 can share the digital materials 402a and 402b to the sub-workspace 420. The multi-user collaboration system 140 can then receive sub-workspace feedback, such as 622a and 622b, in respect of the digital material 402a. As described, the feedback can be received in respect of specific portions of the digital material 302. In FIG. 8, the multi-user collaboration system 140 received the sub-workspace feedback 622a in respect of a gear design from the internal user 504a directly within the digital material 402a. In this example, the multi-user collaboration system 140 also displays the sub-workspace feedback 622a in a discussion interface, shown generally at 640. In some embodiments, the discussion interface 640 can include a notice 650 alerting users of the sub-workspace 420 that any feedback and/or discussion submissions submitted via the sub-workspace 420 will be accessible by all users with access to the sub-workspace 420. The multi-user collaboration system 140 can receive the sub-workspace feedback 622b from the external user 506a assigned to the sub-workspace 420.

At 240, the processor 142 receives a workspace feedback 312 in respect of the one or more digital materials 302 via the workspace 310.

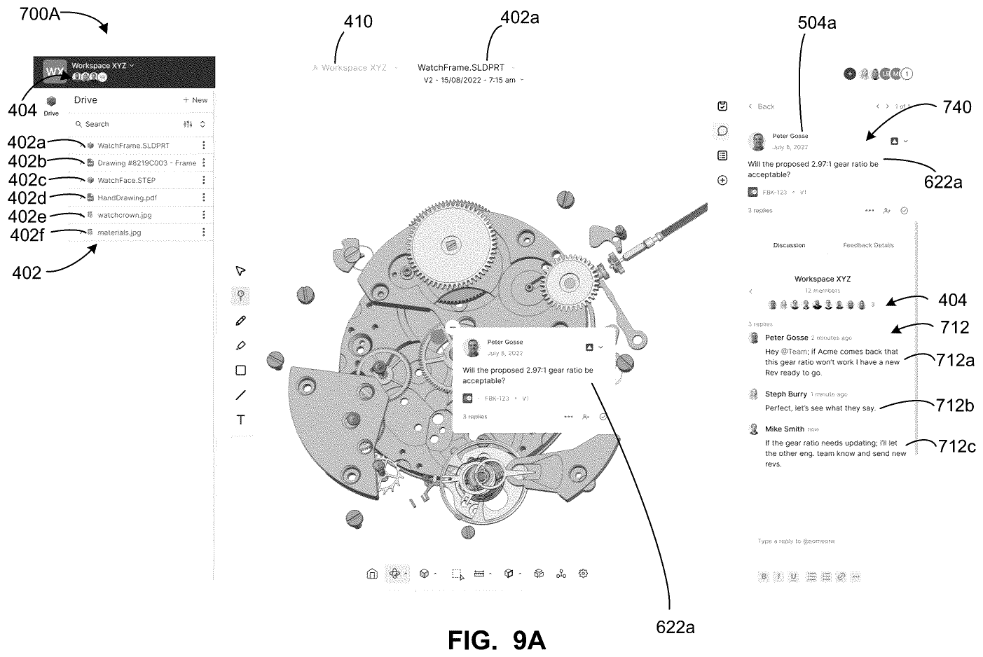

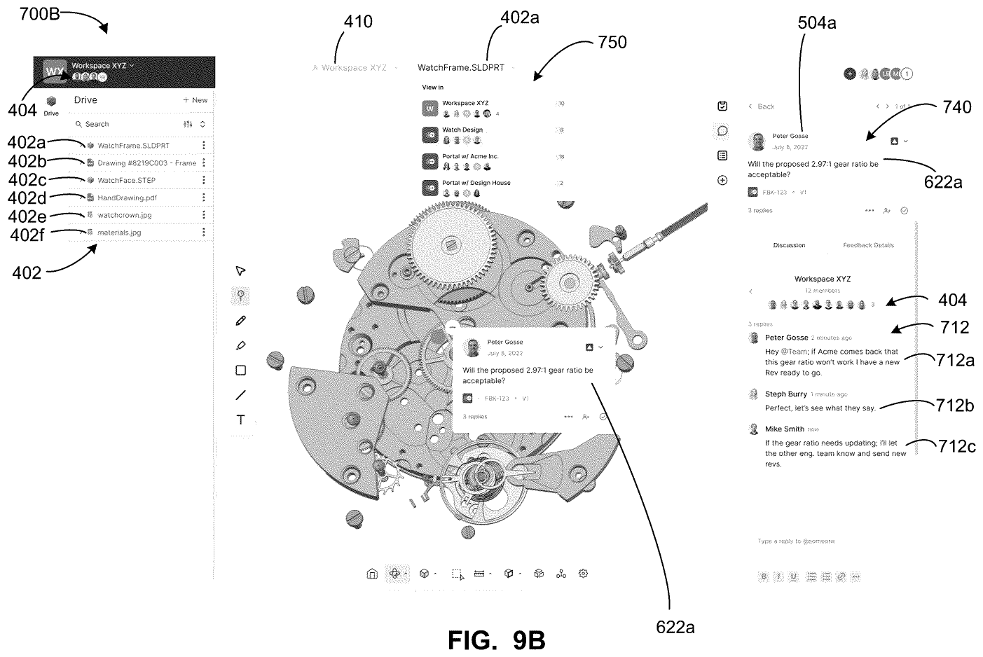

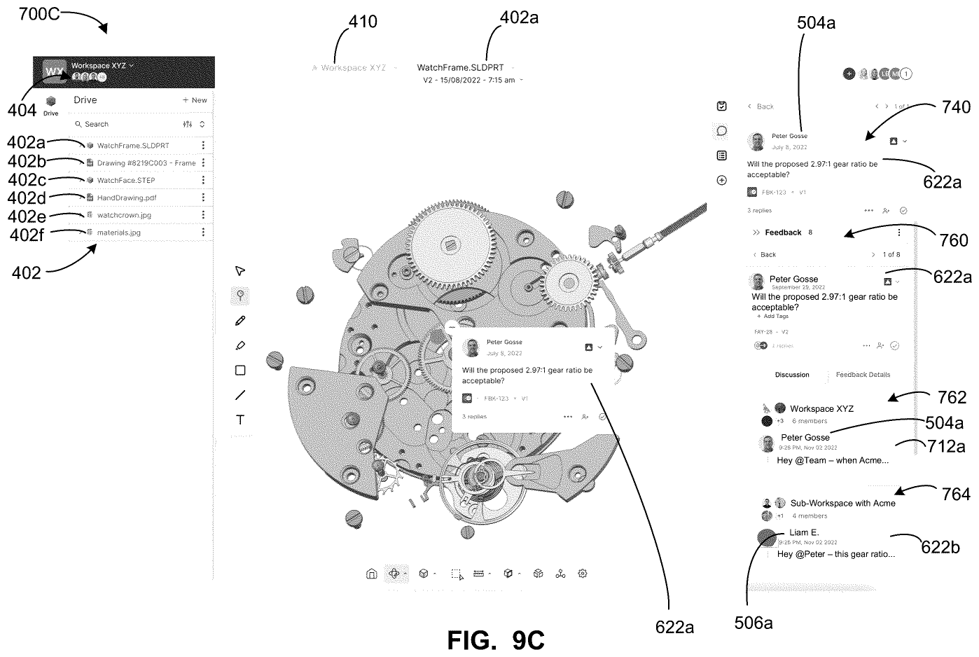

FIG. 9A is a screenshot 700A of the digital material 402a shown in FIG. 8 accessed via the workspace 410. In contrast to FIG. 8, the multi-user collaboration system 140 can receive the workspace feedback 712 (e.g., 712a to 712c) from the internal users 404. The sub-workspace feedback 622a and 622b are also available but the external user 506a cannot access the workspace feedback 712.

FIG. 9B shows another example screenshot 700B of the workspace 410. In this example, the multi-user collaboration system 140 provides a workspace switching interface 750 from which the user can select to view the digital material 402a from another workspace 410 or sub-workspace 420 he/she has access to.

FIG. 9C shows another example screenshot 700C of the workspace 410. In this example, the multi-user collaboration system 140 provides a feedback discussion interface 760 via which the workspace discussion 762 and a sub-workspace discussion 764 in respect of the feedback 622a can be seen.

In some embodiments, the multi-user collaboration system 140 can receive the workspace feedback 312 from the internal user(s) 304 via the sub-workspace 420. When submitting a feedback, the internal user 304 can indicate to the multi-user collaboration system 140 that he/she is submitting the feedback as the workspace feedback 312 so that those with access only to the sub-workspace 320 cannot view that feedback. For example, when the internal user 304 submits the feedback, the multi-user collaboration system 140 can enable the internal user 304 to submit the feedback via the workspace 310 despite the digital material 302 being accessed via the sub-workspace 320. In some embodiments, the multi-user collaboration system 140 can enable the internal user 304 to submit a feedback to the sub-workspace 320 despite the digital material 302 being accessed via the workspace 310. The multi-user collaboration system 140 can provide an interface drop-down box, for example, which can enable the internal user 304 to select what type of feedback he or she is submitting—that is, whether the feedback is the workspace feedback 312 or the sub-workspace feedback 322.

The multi-user collaboration system 140 can also enable the internal user 304 to select workspace feedback 312 to be shared with specific sub-workspace(s) 320, in some embodiments.

At 250, the processor 142 displays a set of feedback on the one or more digital materials 302 to a user.

The set of feedback can include the sub-workspace feedback 322 received via the sub-workspace 320 and the workspace feedback 312 received via the workspace 310 when the user has access to the workspace 310. The set of feedback includes only the sub-workspace feedback 322 when the user has access only to the sub-workspace 320.

In some embodiments, the multi-user collaboration system 140 can automatically determine whether the user is accessing the digital material 302 via the workspace 310. In response to determining the user is accessing the digital material 302 via the workspace 310, the multi-user collaboration system 140 can display the workspace feedback 312 and the sub-workspace feedback 322 as the set of feedback. Otherwise, the multi-user collaboration system 140 can display only the sub-workspace feedback 322.

In some embodiments, the multi-user collaboration system 140 can automatically determine whether the user has access to the workspace 310. For example, the multi-user collaboration system 140 can determine from the user profile associated with the user the access available to that user. In response to determining the user has access to the workplace 310, the multi-user collaboration system 140 can display the workspace feedback 312 and the sub-workspace feedback 322 as the set of feedback. Otherwise, the multi-user collaboration system 140 can display only the sub-workspace feedback 322.

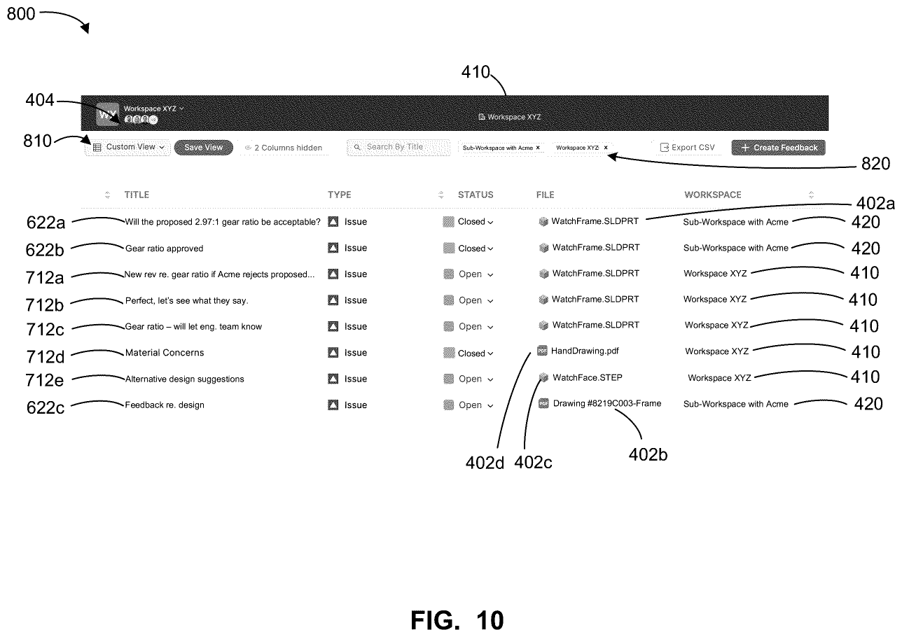

FIG. 10 is a screenshot 800 of an example feedback search interface 810. As can be seen in FIG. 10, the multi-user collaboration system 140 can display the set of feedback in another manner separate from the digital material 302 in respect of which the feedback was received. In this example, the multi-user collaboration system 140 can receive search queries 820 from the user and display the set of feedback to the user according to the search fields and the access assigned to that user. For example, the search query 820 can include specific workspace(s) 310 and/or sub-workspace(s) 320. In the example shown in FIG. 10, the search query 820 includes the sub-workspace with Acme 420 and the Workspace XYZ 410. In some embodiments, the multi-user collaboration system 140 can receive a search query 820 specifying only feedback that have outstanding tasks for the user, regardless of whether the feedback was received via the workspace 310 or sub-workspaces 320 as long as that user had been assigned the task.

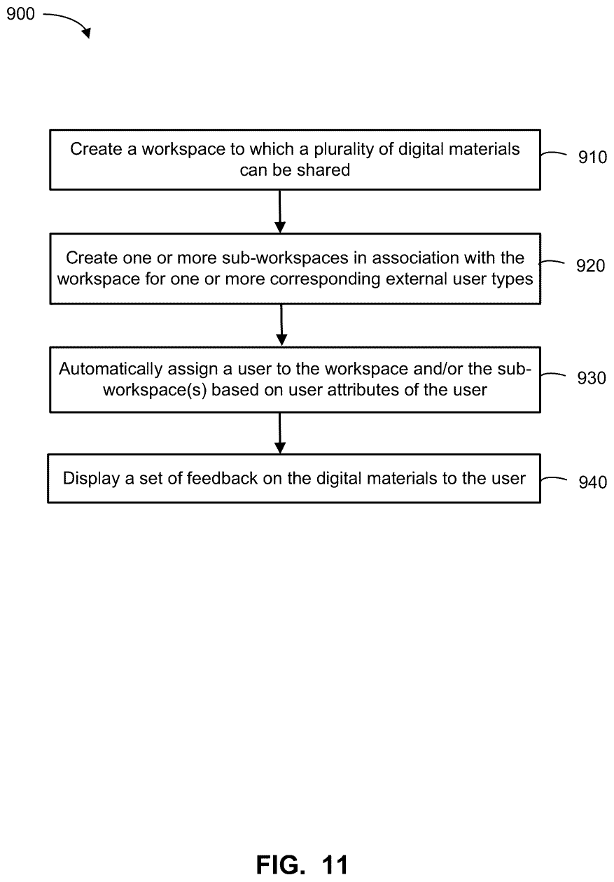

FIG. 11 is a flowchart 900 of another example method of providing the multi-user collaboration system 140.

At 910, the processor 142 creates the workspace 310 to which the digital materials 302 can be shared by one or more internal users 304.

As described with reference to 210, the workspace 310 is an electronic environment to which the digital material(s) 302 can be shared by the internal users 304, and in respect of which users with the associated access level can provide feedback.

At 920, the processor 142 creates one or more sub-workspaces 320 in association with the workspace 310 for one or more corresponding external user types.

As described herein, each sub-workspace 320 can be accessible by an external user 306 associated with a corresponding external user type to provide a sub-workspace feedback 322 in respect of one or more digital materials 302 shared to that sub-workspace 320.

At 930, the processor 142 automatically assigns a user to the workspace 310 and/or one or more sub-workspace(s) 320 based on user attributes of the user.

The multi-user collaboration system 140 can determine user attributes for the user from the user profiles stored in the memory 144 and/or the remote data storage 120. In some embodiments, the multi-user collaboration system 140 can determine the user attributes for the user from a request received by the multi-user collaboration system 140 to register the user into the multi-user collaboration system 140 and/or a request to automatically assign the user to the workspace 310 and the sub-workspace(s) 320. For example, the multi-user collaboration system 140 can determine from the request to register/assign the user embedded user attributes in respect of the user. In another example, the multi-user collaboration system 140 can be directed to another data storage containing the user attributes for the user based on data embedded within the request to register/assign the user.

The user attributes can include, but not limited to, an entity role of the user (e.g., a manager, an assistant, an engineer, etc.), an email domain associated with the user, and an Internet Protocol (IP) address associated with the user.

The multi-user collaboration system 140 can determine the user attributes from the internal entity's identity management system, in some embodiments. The multi-user collaboration system 140 can determine the user attributes defined within the internal entity's system and assign the corresponding users to the workspace 310 and/or sub-workspace(s) 320 also assigned with those attributes. For example, the internal entity can assign each user with a user attribute of the team “mechanical” to the workspace 310 and/or sub-workspace(s) 320a also with the “mechanical” attribute.

In some embodiments, the multi-user collaboration system 140 can identify the workspace 310 and/or sub-workspace(s) 320 for the user by determining whether the user attributes of the user satisfy a workspace identifier assigned to each of the workspace 310 and the sub-workspace(s) 320. The workspace identifier can correspond with a security level and/or role required to access the corresponding workspace 310 or the sub-workspace(s) 320. For example, the multi-user collaboration system 140 can authenticate a user via an identity provider (IdP) service. The identity provider service can also generate a digital identifier for the user based on their user attributes in respect of their expected activity on the multi-user collaboration system 140. The multi-user collaboration system 140 can assign each workspace 310 and sub-workspace(s) 320 with the workspace identifier that corresponds to the minimal digital identifier that would be generated by the identity provider service in order for a user to gain access to the corresponding workspace 310 and/or sub-workspace(s) 320.

The multi-user collaboration system 140 can also automatically update the access assigned to the user based on any changes in the user profiles. For example, when the user exits the internal or external entity, the multi-user collaboration system 140 can detect that change in the user attribute data and remove that user from the associated workspace 310 and/or sub-workspace 320. In another example, when the user's role changes within the internal or external entity, the multi-user collaboration system 140 can determine whether the assigned workspace 310 and/or sub-workspace 320 should be updated based on the updated user attributes.

At 940, the processor 142 displays a set of feedback on the one or more digital materials 302 to the user.

As described herein, the multi-user collaboration system 140 can display to a user with access to the workspace 310 both the sub-workspace feedback 322 received via the sub-workspaces 320 and the workspace feedback 312 received via the workspace 310. When the user only has access to sub-workspace(s) 320, the multi-user collaboration system 140 can only display the associated sub-workspace feedback 322.

FIG. 12 is a flowchart 1000 of another example method of providing the multi-user collaboration system 140.

At 1010, the processor 142 creates the workspace 310 to which the digital materials 302 can be shared by one or more internal users 304.

As described with reference to 210, the workspace 310 is an electronic environment to which the digital material(s) 302 can be shared by the internal users 304, and in respect of which users with the associated access level can provide feedback.

At 1020, the processor 142 receives, from an internal user 304, an external collaboration request to collaborate with an external user type.

The multi-user collaboration system 140 can determine from the external collaboration request the external user type. As described herein, the external user type identifies a type or group of external users based on various characteristics, such as a functionality or service that they may offer.

The multi-user collaboration system 140 can determine from the external collaboration request that the internal user 304 requires collaboration with multiple different external users 306 of the same external user type. In some embodiments, the multi-user collaboration system 140 can determine the external user type automatically based on user data available in respect of the internal user 304, and/or a type of project for which the external collaboration request has been made.

At 1030, in response to receiving the external collaboration request to collaborate with the external user type, the processor 142, creates a sub-workspace 320 in association with the workspace 310 for the external user type, and assigns a sub-workspace user group to the sub-workspace 320.

When the external collaboration request is received, the multi-user collaboration system 140 can automatically create the sub-workspace 320 for the external user type. In some embodiments, the multi-user collaboration system 140 can automatically share a digital material 302 to the sub-workspace 320 based on the external user type. For example, if the external user type corresponds to a supplier type, the multi-user collaboration system 140 can automatically identify digital materials 302 associated with a request for proposal for that supplier type.

The multi-user collaboration system 140 can also assign a sub-workspace user group that includes at least one external user 306 associated with the external user type and at least one internal user 304 to collaborate with the at least one external user 306. The internal user 304 may, in some embodiments, correspond to a functionality user group instead of a specific user.

At 1040, the processor 142 displays the set of feedback on the one or more digital materials 302 to a user.

As described herein, the multi-user collaboration system 140 can display the sub-workspace feedback 322 received via the sub-workspace 320 and the workspace feedback 312 received via the workspace 310 when the user has access to the workspace 310, and only the sub-workspace feedback 322 when the user has access only to the sub-workspace 320.

Access control to the digital materials shared to the workspaces within the multi-user collaboration system 140 is important. In particular, administrative users will want to ensure that unauthorized third-parties do not gain access to the digital materials shared within the multi-user collaboration system 140. Unauthorized distribution of digital materials from the multi-user collaboration system 140 can take place in various manners, such as but not limited to, when an authorized user obtains a copy of the digital material and distributes the digital material outside the multi-user collaboration system 140 (e.g., uploading to the internet, the dark web, or other public data sources, etc.), or a third-party user maliciously accesses the multi-user collaboration system 140 (e.g., through a breach) to obtain the digital material and distributes the digital material outside the multi-user collaboration system 140.

To prevent authorized users from distributing digital materials outside the multi-user collaboration system 140 without authorization, the multi-user collaboration system 140 can ask users to acknowledge the confidential nature of the digital materials and to explicitly agree not to distribute the digital material, especially when a user requests to obtain the digital material—whether via a download and/or screenshot of the digital material, for example.

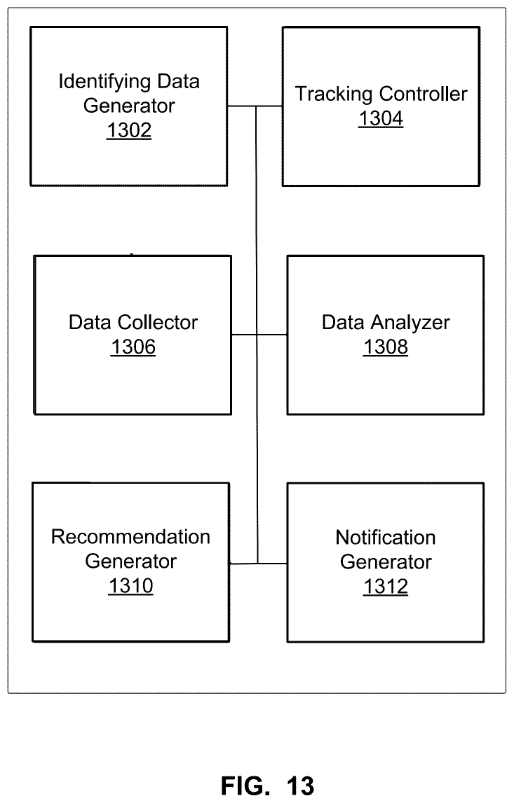

In a more proactive approach, as will be described herein, the multi-user collaboration system 140 can identify when digital materials shared to a workspace have been shared outside the workspace. For example, the multi-user collaboration system 140 can include a monitoring system, such as shown in FIG. 13, for identifying digital materials that have been shared without authorization. Upon identifying that certain digital materials shared to a workspace have been distributed external to the multi-user collaboration system 140 without authorization, the monitoring system may notify relevant users (e.g., users who created the digital material, a workspace administrator, etc.) that the digital materials have been distributed outside the multi-user collaboration system 140.

The monitoring system can monitor public data sources to detect unauthorized copies of digital materials originally shared to a workspace of the multi-user collaboration system 140, investigate unauthorized distributions outside the multi-user collaboration system 140, and generate notifications to the relevant users.

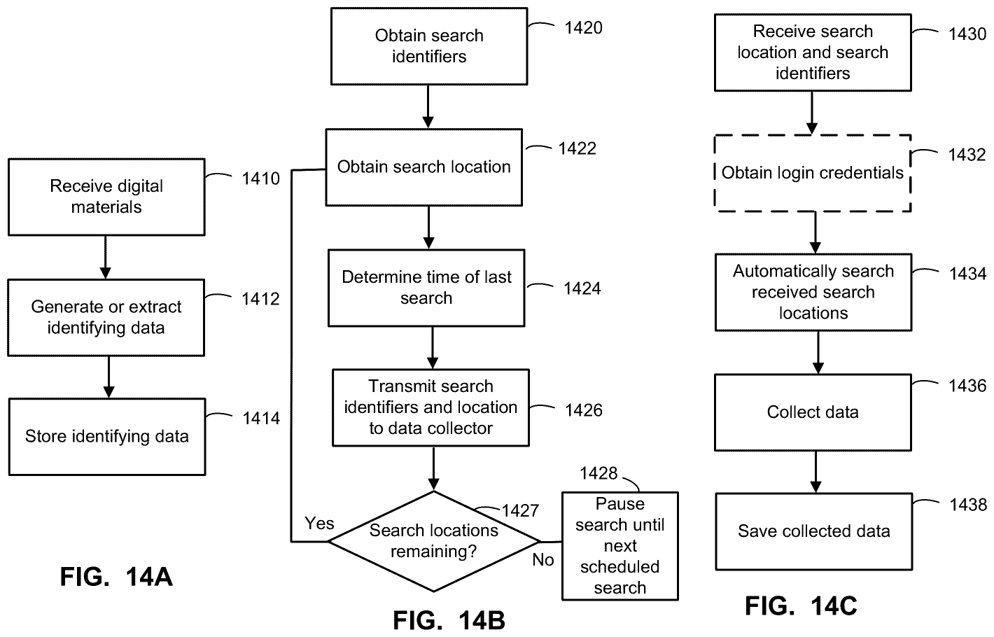

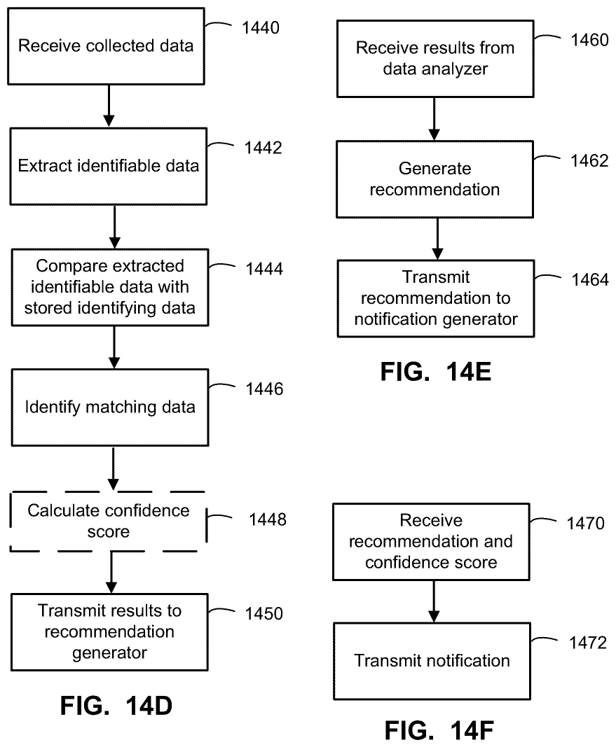

Reference is next made to FIG. 13, which shows a block diagram of the monitoring system for identifying unauthorized distribution of digital materials. As described, the monitoring system can be a subsystem of the multi-user collaboration system 140. Reference will simultaneously be made to FIGS. 14A-14F which are flowcharts of example methods of operating the access monitoring system. The components shown in FIG. 13 can be implemented by a processor, such as processor 142, or another processor of the multi-user collaboration system 140. The components shown in FIG. 13 can be combined into fewer components, and/or split into a greater number of components. As shown, the monitoring system includes an identifying data generator component 1302, a tracking controller 1304, a data collector component 1306, a data analyzer component 1308, a recommendation generator component 1310 and a notification generator component 1312. In some embodiments, the functionalities described with respect to the monitoring system can be implemented via the processor 142.

The identifying data generator component 1302 can be configured to generate identifying data relating to digital materials shared to a workspace. As described, when a digital material is shared to a workspace, a digital record, which can include a digital material identifier, can be associated with the digital material. As shown in FIG. 14A, at 1410, the identifying data generator component 1302 receives digital materials. At 1412, the identifying data generator component 1302 generates and/or extracts identifying data from the digital materials received. For example, identifying data extracted can relate to the contents of the digital material, including the file name of the digital material. The identifying data can uniquely identify each digital material.

The identifying data can be stored in a data store accessible by the monitoring system, such as memory 144, as a digital record of the digital material or in another data storage element. Example identifying data can include, but not limited to, cryptographic hash data generated for the digital material, cryptographic hash data of related digital materials, a unique file identifier (e.g., file name), a unique identifiable embedded artifact (e.g., watermark, non-disruptive file, stenography), user-defined identifying data, or any combination of these.

In some embodiments, when a request to download a document is received by the multi-user collaboration system 140, the identifying data generator component 1302 can associate supplementary identifying data to the digital material. For example, the identifying data generator component 1302 can update the digital record to include information about the digital material downloaded, the user having downloaded the digital material and, in some embodiments, additional information relating to the download event. The supplementary identifying data can subsequently be used by the data analyzer component 1308 to identify a source of unauthorized distribution.

The tracking controller 1304 is configured to control the collection of data by the data collector component 1306. For example, the tracking controller 1304 can control the frequency of data collection so that the data collector 1306 can execute search sessions on a predefined schedule. As shown in FIG. 14B, for each search session, at 1420, the tracking controller 1304 can obtain search identifiers from a data store, such as the memory 144 or the remote data storage 120. Search identifiers can include identifying data generated by the monitoring system, for example, based on the type of digital material or the contents of the digital material and general data that does not identify the digital material specifically but may relate to the environment of the digital material (e.g., company name associated with the digital material or workspace, project name, workspace identifier, user identifier, etc.). The search identifiers can include identifiers specific to the digital material. At 1422, the tracking controller 1304 obtains a search location from a data store, such as the memory 144 or the remote data storage 120. Search locations correspond to data sources from which data is to be collected by the data collector component 1306 and can pre-defined by the monitoring system and in some cases, previously defined by users of a workspace. Example search locations can include, but are not limited to, the dark web, websites, third-party intelligence data, publicly accessible data storage (e.g., Google Drive, AWS S3, Box, Drop Box, etc.). At 1424, the tracking controller 1304 determines when the search location was last searched to determine if the search location should be searched. As described, data can be collected at a predetermined time interval. If the time elapsed between the last search of a search location is greater than the predetermined time interval, the search location may be determined to necessitate searching by the data collector component 1306. In some embodiments, determining when the search location was last searched includes obtaining tracking data (e.g., a search session identifier) associated with the last search. At 1426, the tracking controller 1304 transmits the search identifiers and the search location to the data collector component 1306. At 1427, the tracking controller 1304 determines if all search locations have been searched. If there are no remaining search locations to be searched, the tracking controller 1304 proceeds to 1428, where the search is paused until the next scheduled search (e.g., the next search session). If there are remaining search locations to be searched, the tracking controller 1304 returns to 1422 and obtains a subsequent search location until all search locations have been assessed. In some embodiments, the tracking controller 1304 can communicate with the data collector component 1306 as the data collector component 1306 is collecting data to determine that a search location has been searched. Alternatively, the tracking controller 1304 can retrieve search records stored by the data collector component 1306 from a data store, for example, at 1427 to determine that a search location transmitted at 1426 has been searched.

The data collector component 1306 is configured to collect data from a plurality of data sources. The data sources can include any type of public data source from which data can be collected (e.g., dark web, public internet websites, third party intelligence, publicly accessible data storages), including data sources requiring login credentials, if the login credentials are known. The data collected can include any type of data provided by public data sources, including digital materials similar to the types shared to workspaces of the multi-user collaboration system 140. The data collector 1306 can include a web crawler. The data collector component 1306 can be configured to collect data at a predetermined time interval, as determined by the tracking controller 1304. The operation of the data collector component 1306 can be determined by the tracking controller 1304. As shown in FIG. 14C, at 1430, the data collector component 1306 can receive one or more search locations and search identifiers from the tracking controller 1304, corresponding to the locations and identifying data to be searched.

In some embodiments, at 1432, if a search location of the one or more search locations requires login credentials (e.g., the location to be searched is third party intelligence, or a password protected data storage), the data collector component 1306 can retrieve login credentials associated with the location to be searched from a data store, which can store credential data. For example, the login credentials can be previously provided by an internal user and stored in the data store.

At 1434, the data collector component 1306 automatically searches the search locations provided by the tracking controller 1304 using the search identifier.

At 1436, the data collector component 1306 collects data that generally match the search identifiers. The data collected can then be transmitted to the data analyzer component 1308 and/or stored in a database at 1438.

The data analyzer component 1308 can be configured to analyze the data collected by the data collector 1306 to identify instances of unauthorized distribution of digital materials previously shared to a workspace. For example, the data collected at 1436 by the data collector component 1308 can be further analyzed by the data analyzer component 1308. The search identifiers used by the data collector component 1306 can include general search identifiers (e.g., company name, file name, project name, workspace or user identifier, etc.). The data analyzer component 1308 can be configured to further evaluate the matches. For example, for data security reasons, search identifiers may be intentionally broad, if collecting data from the search location causes the search location to obtain information about the search identifiers used. Matches identified by the data collector component 1306 may accordingly in some cases be incorrect.

As shown in FIG. 14D, at 1440, the data analyzer component 1308 can receive or retrieve collected data. For example, the data analyzer component 1308 can receive an indication from the data collector component 1306 that data has been collected and stored and/or that a match between the data collected and the search identifiers has been detected. The data analyzer component 1308 can then retrieve collected data from a data storage, such as, but not limited to the memory 144 and the remote data storage 120 associated with the match. The data analyzer component 1308 can then further analyze the received data. To identify instances of unauthorized distribution of a digital material, at 1442, the data analyzer component 1308 analyzes the data collected to extract identifiable data. Identifiable data can include identifying data and data appearing to be identifying data. For example, the data analyzer component 1308 can be configured to download a suspected unauthorized copy of a digital material from a search location and analyze the digital material to determine if the suspected copy includes the identifying data of the original digital material (e.g., unique identifiable embedded artifact) or if the same identifying data can be generated from the suspected unauthorized copy (e.g., cryptographic hash data). The data analyzer component 1308 can refer to the stored identifying data to determine if the identifiable data of the suspected unauthorized copy matches the identifying data of the originally-shared digital material. At 1444, the data analyzer component 1308 compares the extracted identifiable data with stored identifying data previously stored by the identifying data generator 1302 at 1414 to, at 1446, identify matching data at least between a portion of each of the data being compared. Matching data can indicate that the collected data corresponds to a digital material shared to a workspace, which can indicate that the digital material was distributed outside the multi-user collaboration system 140.

In some embodiments, at 1448, the data analyzer component 1308 can generate a confidence score indicative of the data analyzer component's 1308 confidence that data collected corresponds to a digital material shared to a workspace. The confidence score can be calculated based on for example, the number and/or the types of matching identifying data.

The data analyzer component 1308 can identify the digital material associated with the matching data and the location of the identified unauthorized copy and correlate any data associated with the digital material with the location of the unauthorized copy.

In some embodiments, the data analyzer component 1308 can identify, based on the identifiable data extracted, a source of the unauthorized distribution of the digital material. For example, the data analyzer component 1308 may determine that the unauthorized copy is associated with a particular download event.

At 1450, the data analyzer component 1308 transmits the identified matches and associated confidence scores, if determined, to the recommendation generator component 1310.

The recommendation generator component 1310 is configured to generate a recommendation in response to matching data being identified by the data analyzer component 1308.

As shown in FIG. 14E, at 1460, the recommendation generator component 1310 receives an identified match and an associated confidence score.

At 1462, the recommendation generator component 1310 generates a recommendation. The recommendation can include a notification. The recommendation can be based on, for example, the digital material identified, the location of the identified unauthorized copy and/or the confidence score. For example, the recommendation generator component 1310 may only generate a recommendation if the confidence score exceeds a pre-determined threshold or may generate different types of recommendations based on the confidence score and/or the type of user. The recommendation may also vary based on the type of digital material. For example, if the digital material is an export-regulated document, the recommendation may include a notification to governmental agencies. As another example, if the confidence score is low (e.g., falls below a pre-determined threshold), the recommendation generator component 1310 may only generate a notification alerting users that a potential unauthorized distribution of a digital material has been identified while if the confidence score is high (e.g., is above a pre-determined threshold), the recommendation generator 1310 may notify the workspace administrator or a user responsible for responding to security incidents (e.g., Security Incident Response Team) associated with the workspace and provide specific details about the authorized copy identified, the location of the identified unauthorized copy, and information about the source of the unauthorized distribution

At 1464, the recommendation generator component 1310 transmits the recommendation to the notification generator 1312.

The notification generator component 1312 is configured to generate a notification in response to unauthorized distribution of digital materials being identified.

As shown in FIG. 14F, at 1470, the notification generator component 1312 receives a recommendation and a confidence score from the recommendation generator component 1310. At 1472, the notification generator component 1312 can transmit the notification to an internal user or an external user (e.g., a workspace administrator), via for example the computing device 110. For example, the notification can be provided as a visual indicator on the corresponding digital material shared to the workspace, as a notification displayed on the workspace or as a notification external to the multi-user collaboration system 140 (e.g., email, text message).

The notification can include various information related to the digital material and/or the unauthorized distribution, such as but not limited to, a confidence score, information relating to the digital material and/or the individual responsible for the unauthorized distribution, information relating to the location of the unauthorized copy, and/or a recommended action. The information transmitted in the notification can vary based on the source of the unauthorized distribution.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred herein as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g., ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims. Also, in the various user interfaces illustrated in the drawings, it will be understood that the illustrated user interface text and controls are provided as examples only and are not meant to be limiting. Other suitable user interface elements may be possible.

1. A method of providing a multi-user collaboration system involving one or more external users, the method comprising:
creating a workspace to which a plurality of digital materials can be shared by one or more internal users;
receiving, from an internal user of the one or more internal users, an external collaboration request to collaborate with an external user type;
in response to receiving the external collaboration request to collaborate with the external user type:
creating a sub-workspace in association with the workspace for the external user type, the sub-workspace accessible by an external user associated with the external user type to provide a sub-workspace feedback in respect of one or more digital materials of the plurality of digital materials shared to the sub-workspace; and
assigning a sub-workspace user group to the sub-workspace, the sub-workspace user group comprising at least one external user associated with the external user type and at least one internal user of the one or more internal users to collaborate with the at least one external user; and
displaying a set of feedback on the one or more digital materials to a user, the set of feedback comprising the sub-workspace feedback received via the sub-workspace and a workspace feedback received via the workspace when the user has access to the workspace, and the set of feedback includes only the sub-workspace feedback when the user has access only to the sub-workspace.

2. The method of claim 1, wherein displaying the set of feedback on the one or more digital materials to the user comprises:
determining whether the user is accessing the one or more digital materials via the workspace; and
in response to determining the user is accessing the one or more digital materials via the workspace, displaying the workspace feedback and the sub-workspace feedback as the set of feedback, otherwise, displaying only the sub-workspace feedback.

3. The method of claim 1, wherein displaying the set of feedback on the one or more digital materials to the user comprises:
determining whether the user has access to the workspace; and
in response to determining the user has access to the workplace, displaying the workspace feedback and the sub-workspace feedback as the set of feedback, otherwise, displaying only the sub-workspace feedback.

4. The method of claim 1 further, in response to receiving the external collaboration request with the external user type, automatically sharing at least one digital material from the plurality of digital materials to the sub-workspace based on the external user type.

5.-7. (canceled)

8. A multi-user collaboration system involving one or more external users, the multi-user collaboration system comprising:
a memory operable to store a plurality of digital materials to be shared by one or more internal users, a sub-workspace feedback in respect of one or more digital materials of the plurality of digital materials shared to a sub-workspace, and a workspace feedback in respect of the one or more digital materials; and
a processor configured to:
create a workspace to which the plurality of digital materials can be shared by the one or more internal users;
receive, from an internal user of the one or more internal users, an external collaboration request to collaborate with an external user type;
in response to receiving the external collaboration request to collaborate with the external user type:
create a sub-workspace in association with the workspace for the external user type, the sub-workspace accessible by an external user associated with the external user type to provide the sub-workspace feedback in respect of the one or more digital materials shared to the sub-workspace; and
assign a sub-workspace user group to the sub-workspace, the sub-workspace user group comprising one or more external users associated with the external user type and at least one internal user of the one or more internal users to collaborate with the one or more external users; and
display a set of feedback on the one or more digital materials to a user, the set of feedback comprising the sub-workspace feedback received via the sub-workspace and the workspace feedback received via the workspace when the user has access to the workspace, and the set of feedback includes only the sub-workspace feedback when the user has access only to the sub-workspace.

9. The multi-user collaboration system of claim 8, wherein the processor is configured to:
determine whether the user is accessing the one or more digital materials via the workspace; and
in response to determining the user is accessing the one or more digital materials via the workspace, display the workspace feedback and the sub-workspace feedback as the set of feedback, otherwise, displaying only the sub-workspace feedback.

10. The multi-user collaboration system of claim 8, wherein the processor is configured to:
determine whether the user has access to the workspace; and
in response to determining the user has access to the workplace, display the workspace feedback and the sub-workspace feedback as the set of feedback, otherwise, display only the sub-workspace feedback.

11. The multi-user collaboration system of claim 8, wherein the processor is further configured to, in response to receiving the external collaboration request with the external user type, automatically share at least one digital material from the plurality of digital materials to the sub-workspace based on the external user type.

12. The multi-user collaboration system of claim 8, wherein the processor is configured to:
create one or more sub-workspaces for the external user type, each sub-workspace of the one or more sub-workspace being associated with a different external user associated with the external user type, and each different external user having access only to the sub-workspace feedback provided within the sub-workspace to which that different external user has access.

13.-15. (canceled)

16. A method of providing a multi-user collaboration system involving one or more external users, the method comprising:
creating a workspace to which a plurality of digital materials can be shared by one or more internal users;
creating one or more sub-workspaces in association with the workspace for one or more corresponding external user types, each sub-workspace accessible by an external user associated with a corresponding external user type to provide a sub-workspace feedback in respect of one or more digital materials of the plurality of digital materials shared to that sub-workspace;
automatically assigning a user to one or more of the workspace and the one or more sub-workspace based on one or more user attributes of the user; and
displaying a set of feedback on the one or more digital materials to the user, the set of feedback comprising the sub-workspace feedback received via the one or more sub-workspaces and a workspace feedback received via the workspace when the user has access to the workspace, and the set of feedback includes only the sub-workspace feedback received via the one or more sub-workspaces to which the user has access.

17. The method of claim 16, wherein automatically assigning the user to the one or more of the workspace and the one or more sub-workspaces comprises:
identifying the one or more of the workspace and the one or more sub-workspaces for the user by determining whether the one or more user attributes of the user satisfy a workspace identifier assigned to each of the workspace and the one or more sub-workspaces.

18. The method of claim 16, wherein displaying the set of feedback on the one or more digital materials to the user comprises:
determining whether the user is accessing the one or more digital materials via the workspace; and
in response to determining the user is accessing the one or more digital materials via the workspace, displaying the workspace feedback and the sub-workspace feedback as the set of feedback, otherwise, displaying only the sub-workspace feedback.

19. The method of claim 16, wherein displaying the set of feedback on the one or more digital materials to the user comprises:
determining whether the user has access to the workspace; and
in response to determining the user has access to the workplace, displaying the workspace feedback and the sub-workspace feedback as the set of feedback, otherwise, displaying only the sub-workspace feedback.

20. The method of claim 16, wherein creating the one or more sub-workspaces in association with the workspace for the one or more corresponding external user types comprises:
automatically sharing at least one digital material from the plurality of digital materials to the one or more sub-workspace based on the one or more corresponding external user type.

21. The method of claim 16, wherein the one or more sub-workspaces comprises at least two sub-workspaces created for the same external user type, and
the method further comprises automatically assigning two different external users associated with the same external user type to the at least two sub-workspaces, each different external user having access only to the sub-workspace feedback provided within the sub-workspace to which that different external user has access.

22.-31. (canceled)

32. A method of providing a multi-user collaboration system involving one or more external users, the method comprising:
creating a workspace to which a plurality of digital materials can be shared by one or more internal users;
creating a sub-workspace in association with the workspace for an external user type, the sub-workspace accessible by an external user associated with the external user type to provide a sub-workspace feedback in respect of one or more digital materials of the plurality of digital materials shared to the sub-workspace;
receiving the sub-workspace feedback in respect of the one or more digital materials via the sub-workspace;
receiving a workspace feedback in respect of the one or more digital materials via the workspace; and
displaying a set of feedback on the one or more digital materials to a user, the set of feedback comprising the sub-workspace feedback received via the sub-workspace and the workspace feedback received via the workspace when the user has access to the workspace, and the set of feedback includes only the sub-workspace feedback when the user has access only to the sub-workspace.

33. The method of claim 32, wherein displaying the set of feedback on the one or more digital materials to the user comprises:
determining whether the user is accessing the one or more digital materials via the workspace; and
in response to determining the user is accessing the one or more digital materials via the workspace, displaying the workspace feedback and the sub-workspace feedback as the set of feedback, otherwise, displaying only the sub-workspace feedback.

34. The method of claim 32, wherein displaying the set of feedback on the one or more digital materials to the user comprises:
determining whether the user has access to the workspace; and
in response to determining the user has access to the workplace, displaying the workspace feedback and the sub-workspace feedback as the set of feedback, otherwise, displaying only the sub-workspace feedback.

35. The method of claim 32 further comprises, for each sub-workspace feedback, providing a workspace discussion for receiving one or more workspace discussion entries from the one or more internal users and a sub-workspace discussion for receiving one or more sub-workspace discussion entries from at least the external user associated with the sub-workspace.

36. The method of claim 35, wherein displaying the set of feedback on the one or more digital materials to the user comprises:
displaying the sub-workspace feedback, the sub-workspace discussion and the workspace discussion associated with each sub-workspace feedback, and the workspace feedback received via the workspace when the user has access to the workspace, otherwise, displaying only the sub-workspace feedback and the sub-workspace discussion associated with each sub-workspace feedback when the user has access only to the sub-workspace.

37. The method of claim 32, wherein creating the sub-workspace in association with the workspace for the external user type comprises:
creating one or more sub-workspaces for the external user type, each sub-workspace of the one or more sub-workspace being associated with a different external user associated with the external user type, and each different external user having access only to the sub-workspace feedback provided within the sub-workspace to which that different external user has access.

38.-59. (canceled)
